(19) United States
(12) Patent Application Publication
(10) Pub. No.: US 2014/0000986 A1
(43) Pub. Date: Jan. 2, 2014

(54) DEVICE AND METHOD FOR FASTENING AND ALIGNING A GUIDE RAIL

(71) Applicant: Daniel Quinn, Budd Lake, NJ (US)

(72) Inventor: Daniel Quinn, Budd Lake, NJ (US)

(21) Appl. No.: 13/536,394

(22) Filed: Jun. 28, 2012

(51) Int. Cl. B66B 7/02; E04G 21/14

(52) U.S. Cl. 187/408; 52/741.1

(57) ABSTRACT

A mounting device in an elevator installation for the fastening and alignment of a guide rail, wherein the guide rail has a fastening section, particularly a rail foot, includes a first limb and a second limb, wherein the first limb has a first setting element and the second limb a second setting element, wherein the limbs are fixed in the elevator installation in such a manner that a section, which extends along the guide direction of the guide rail, of the fastening section can be arranged between the first and second limbs and the position of the section of the fastening section of the guide rail is variable and/or fixable within the elevator installation by adjustment of the first and the second setting elements. A method for fastening and aligning the guide rail by the mounting device is provided.

### FIELD

The invention relates to a method and a device for fastening and aligning a guide rail of an elevator installation.

### BACKGROUND

An elevator installation arranged in the elevator shaft comprises a movable elevator car. The elevator car is guided along its travel path at guide rails. The guide rails are fastened in the elevator installation. In the case of a vertical travel path a vertical alignment of these guide rails is then necessary so as to be able to guarantee, for example, elevator car travel free of vibration. For this purpose the guide rails are aligned at the time of their installation in the elevator installation.

Known fastening devices for guide rails comprise clips with the help of which the individual guide rail is pressed against a support construction. An alignment of the guide rail can be undertaken if screws which fix these clips are not firmly tightened after a first fastening process. The alignment can then be undertaken with the help of, for example, a striking tool. As soon as the guide rail is aligned the screws can finally be firmly tightened in a second fastening process in such a manner that the alignment of the guide rail which has been undertaken is permanent.

It is problematic with such a solution that such an alignment of the guide rails is time-consuming, because the alignment undertaken with the help of the striking tool frequently has to be corrected from both sides.

### SUMMARY

It is therefore the object of the invention to create a method and a device for fastening and aligning a guide rail, which allows a shortened installation time of the guide rail.

The object is fulfilled by a mounting device of an elevator installation for the fastening and alignment of a guide rail, which has a fastening section, particularly a rail foot, the mounting device comprising: a first limb and a second limb, wherein the first limb has a first setting element and the second limb a second setting element, wherein the limbs are fixed in the elevator installation in such a manner that a section, which extends along the guide direction of the guide rail, of the fastening section can be arranged between the first and second limbs and the position of the section of the fastening section of the guide rail is variable and/or fixable within the elevator installation by adjustment of the first and the second setting elements.

The mounting device can be part of a guide rail system with at least one fixing device, by means of which the guide rail is fastenable to a support structure. The fixing device comprises elements which permit fixing of the guide rail in the elevator installation.

The object is also fulfilled by a method of fastening and aligning a guide rail, which comprises the following steps:
arranging a section, which extends along the guide direction of the guide rail, of a fastening section of the guide rail between a first limb and a second limb of a mounting device,
adjusting a first setting element of the mounting device for aligning the guide rail, wherein a position of the section of the fastening section between the first and second limbs is predeterminable by means of adjustment of the first setting element, wherein the section adopts this position when the fastening and alignment of the guide rail is concluded, and
adjusting a second setting element of the mounting device for the fastening of the guide rail.

In the sense of this description “alignment” refers substantially to a displacement of the guide rail transversely to the guide direction, which is determined by the guide rail, without in that case substantially changing the spacing of the guide rail from the support structure.

There is increasingly the requirement to manage the mounting of elevator installations as quickly as possible. This applies particularly to the mounting of guide rails, because this working step can occasion a substantial expenditure of time, particularly if, for example, not only a counterweight, but also an elevator car are to be guided by means of these guide rails. Usually, an individual one of the guide rails is initially fixed to a support structure. In a succeeding working step the guide rail is aligned at the support structure when fixing has already been carried out.

To that extent time is often wasted in the mounting of the guide rails. The alignment takes place by hitting the fastening section of the guide rail by a striking tool. The striking tool can be, for example, a conventional hammer. Due to stresses which arise and are caused by the fixing of the guide rail there is the difficulty for the engineer of applying an appropriate amount of force for the alignment. An additional time loss usually results therefrom, because the state of an ideal alignment in the aligning of the guide rail by the striking tool is frequently exceeded in that the engineer hits the fastening section too hard.

In order to minimize this expenditure of time it was sought to combine the method steps for fastening the guide rail on the one hand and for aligning the guide rail on the other hand. This is achieved by a first one of two setting elements of the mounting device fixed in the elevator installation being brought into a position which in the case of the fastening section of the guide rail contacting the setting element mounted thereon leads to accomplishing the alignment of the guide rail. After arrangement of a section of the fastening section between the two setting elements of the mounting device has taken place the setting element is fixed to the fastening section so that the two setting elements contact the fastening section. To that extent the fastening section of the guide rail is clamped in place and fixed between the two setting elements.

In a development of the mounting device an adjustment of the first setting element or of the second setting element produces a change in the spacing of the two setting elements. To that extent an arrangement of the mentioned section between the limbs as well as an alignment and fixing of this section can be simplified.

In a development the mounting device comprises a connecting web to which the first and second limbs are fixed. To that extent both the first and second limbs can be fixed to a support structure in one working step. Thus, with respect to time for mounting the elevator installation no additional time is required in order to suitably space the first limb from the second limb.

In a development of the mounting device at least one of the setting elements comprises a shaped element which is constructed in such a manner that the edge region can be brought into engagement with the fastening section of the guide rail. It is advantageous that fastening of the guide rail to the support structure can be simplified in that way. No additional elements are needed in order to press the fastening section or the guide rail against the support structure.

In a development of the mounting device at least the first limb has a guide hole for guidance and adjustment of the associated setting element. In that way there is a possibility of managing not only a simple, but also a robust connection between one of the setting elements with the associated limb. The first setting element can preferably have a thread and the guide hole associated with the first element preferably a mating thread. Thus, the first setting element, for example a screw, can be guided in simple manner at the associated limb. Adjustment of the first setting element for alignment of the guide rail can then be realized by simple tools. The first setting element can have at least one mounting nut for fixing the first setting element to the first limb. It is advantageous, for example, that forces which act on the first setting element due to stresses in the guide rail can be transmitted in simple manner to the associated limb. The second setting element can obviously have the same features as the first setting element.

In a development of the method the guide rail is fixed to a support structure by means of at least one fixing device. By means of this method step there is the possibility of being able to fix a guide rail, which is aligned by means of mounting devices, at further points, which can produce an additional saving of time.

### DESCRIPTION OF THE DRAWINGS

The invention is explained in more detail in the following by way of figures, in which:

FIG. 1 shows an elevator installation with guide rails in cross-section;

FIG. 2 shows a mounting device of an elevator installation and a guide rail in cross-section;

FIG. 3 shows a guide rail system with a mounting device and a fixing device;

FIG. 4 shows the fixing device of FIG. 3 in cross-section; and

FIG. 5 shows a first limb of a mounting device.

### DETAILED DESCRIPTION

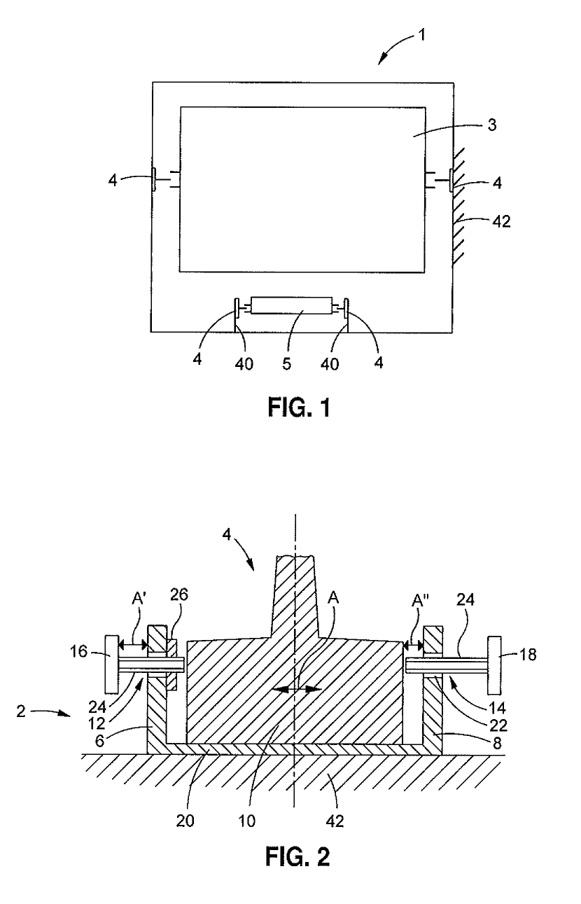

FIG. 1 shows components of an elevator installation 1 in cross-section. The elevator installation 1 comprises an elevator car 3 and guide rails 4. The elevator installation 1 can additionally comprise a counterweight 5, wherein both the elevator car 3 and the counterweight 5 are components to be guided in the elevator installation 1. Each component to be guided is movably arranged at the guide rails 4 associated therewith. Each of the guide rails 4 is fastened to a support structure, for example to a shaft wall 42 or to a support frame 40.

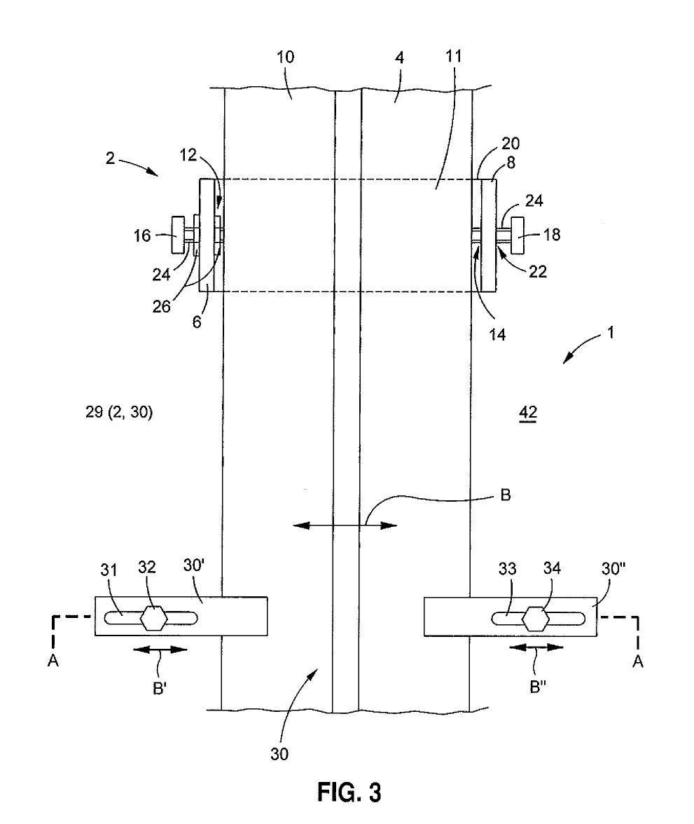

FIGS. 2 and 3 show a mounting device 2 of an elevator installation 1 to which a guide rail 4 is fastened. The guide rail 4 has a fastening section 10 which can be constructed as a rail foot. The mounting device 2 has a first limb 6 and a second limb 8. The first and second limbs 6 and 8 are fixed to a support structure, for example to a shaft wall 42, and can be connected by a connecting web 20. A section, which extends along the guide rail 4, of the fastening section 10 of the guide rail 4 is arranged between the first limb 6 and the second limb 8. The first limb 6 has a first setting element 16. The second limb 8 has a second setting element 18. A section 11, which extends along the guide direction of the guide rail 4 and which is illustrated in FIG. 3, of the fastening section 10 is clamped in place between the limbs 6 and 8 by means of the first and second setting elements 16 and 18, thus fixed. A guide hole 12 or 14 associated with the first or second limb 6 or 8 can serve for guidance of the first or second setting elements 16 or 18. The first and/or second setting element 16, 18 can accordingly have a thread 24. A retaining nut 26 can be screwed onto this thread 24 in order to, for example, be able to adjust the setting element 16 at the associated first limb 6. The limb 8, the setting element 18 of which has the thread 24, can have a mating thread 22 in order to be able to adjust this setting element 18 provided with the thread 24.

During mounting of the guide rail 4 the mounting device 2 is fixed to the support structure at a predeterminable position along an intended course of the guide rail 4. The section 11, which extends along the guide direction of the guide rail 4, of the fastening section is arranged between the first and the second limbs 6, 8. This section 11 is movable along a direction A between the first and second setting elements 16, 18 as long as the first and second setting elements 16, 18 do not contact the fastening section 10. The direction A is oriented substantially orthogonally to the guide direction of the guide rail 4. For example, the guide rail 4 can be oriented with a plumb-bob. Accordingly, the first setting element 6 can be adjusted by means of a movement A′ in such a manner that when the fastening section 10 contacts the first setting element 16 the guide rail 4 is regarded as aligned in the section 11. The second setting element 18 can accordingly be adjusted by means of a movement A″ so that both the first and second setting elements 16, 18 contact the fastening section 10. Contacting of both the first and second setting elements 16, 18 means that the section 11 of the fastening section 10 is fixed in the elevator installation 1. By means of release of a first one of the two setting elements 16, 18 and fixing of the second one of the two setting elements 16, 18 in such a manner that the section 11 is fixed again, it is possible to carry out an easily performable subsequent fine adjustment.

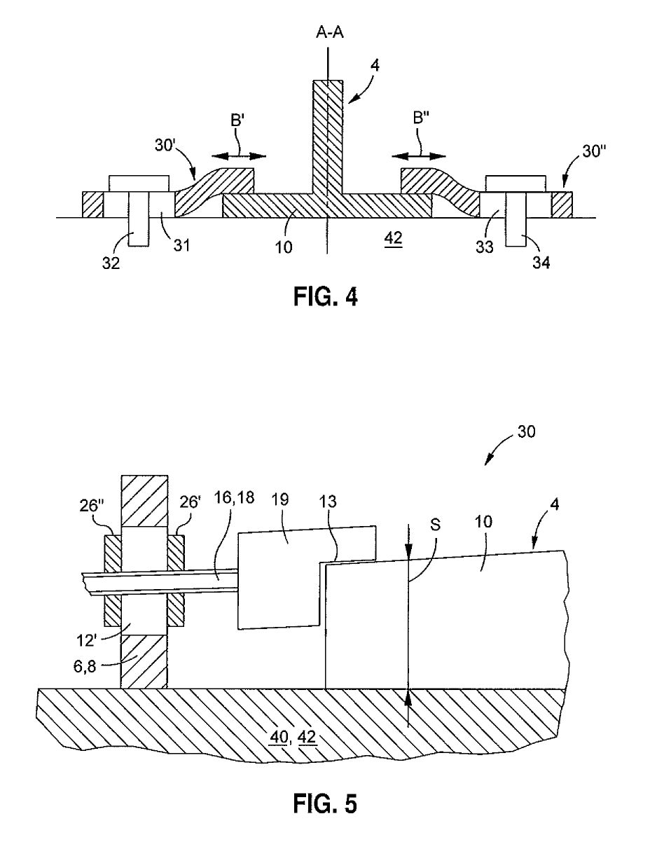

FIG. 3 shows a guide rail system 29 for fastening the guide rail 4 to the support structure, for example the shaft wall 42. The guide rail system 29 comprises, in addition to the at least one mounting device 2, a fixing device 30 which is also shown in FIG. 4 in cross-section. The fixing device 30 is, for example, constructed as a clamping device.

To that extent the guide rail 4 can be oriented in the elevator installation 1 in that the guide rail 4 is fixed by means of the mounting device 2. An additional fixing of the guide rail 4 could be required due to, for example, the mechanical loading of the guide rail 4 during movement of the components to be guided. The additional fixing can be realized by the fixing device 30.

The fixing device 30 comprises two clamping elements 30′, 30″ which press the fastening section of the guide rail 4 in its region adjoining the clamping elements 30′, 30″ against the support structure. The clamping elements 30′, 30″ can, for example, be fixed to the shaft wall 42 by means of screws 32, 34. The clamping elements 30′, 30″ can be matched in the shape thereof to the shape of the fastening section 10 and have slots 31, 33 for the purpose of subsequent fine adjustment of the guide rail 4. In the case of fine adjustment of that kind the clamping elements 30′, 30″ can be displaced along a direction B′, B″, wherein this direction B′, B″ is oriented substantially orthogonally to the guide direction of the guide rail 4.

FIG. 5 shows a first limb 6 of a mounting device 30 according to an embodiment. The first limb 6 is fixed to a support structure 40, 42 and has a first setting element 16. The first setting element 16 can comprise a shaped element 19 matched in substantially shape-coupling manner to the fastening section 10 of a guide rail 4. Accordingly, the shaping element 19 has an edge region 13 which can be brought into engagement with the fastening section 10 of the guide rail 4. It is thereby possible to prevent the fastening section 10 of the guide rail 4 from detaching or coming away from the support structure.

Depending on the respective selection of the type of guide rail 4 used, the fastening section 10 of the respective guide rail 4 can have an individual thickness S. In order to adapt the first limb 6 with the first setting element 16 to this thickness S the first limb 6 can have guide hole in form of a slot 12′. The first setting element 16 can have a thread 24 and retaining nuts 26′, 26″ in order to be able to fasten the first setting element 16 to the first limb 6 having the slot 12′. A second limb of the mounting device 30 can be constructed as per the first limb 6. By means of such a construction of the first limb 6 and of the setting element 16 it can additionally be achieved that the fastening section 10 of the guide rail 4 when the shaped element 19 contacts the fastening section 10 can be pressed against the support structure 40, 42.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A mounting device of an elevator installation for the fastening and alignment of a guide rail, wherein the guide rail has a fastening section, comprising:
a first limb and a second limb, wherein the first limb has a first setting element and the second limb has a second setting element, the limbs being fixed in the elevator installation wherein a section, which extends along a guide direction of the guide rail, of the fastening section is arranged between the first and second limbs and a position of the section of the fastening section of the guide rail is at least one of variable and fixable within the elevator installation by adjustment of the first and the second setting elements.

2. The mounting device according to claim 1 wherein an adjustment of the first setting element or of the second setting element produces a change in a spacing between the first and second setting elements.

3. The mounting device according to claim 1 including a connecting web to which the first and second limbs are fixed.

4. The mounting device according to claim 1 wherein the first and second setting elements each have an edge region which is formed for engagement with the fastening section of the guide rail.

5. The mounting device according to claim 1 wherein at least one of the first and second limbs has a guide hole for guidance and adjustment of a corresponding one of the first and second setting elements.

6. The mounting device according to claim 5 wherein the first setting element has a thread and the guide hole associated with the first setting element has a mating thread.

7. The mounting device according to claim 5 wherein the first setting element has at least one retaining nut for fixing the first setting element at the first limb.

8. A guide rail system of an elevator installation for the fastening and alignment of a guide rail, wherein the guide rail has a fastening section, comprising:
a mounting device having a first limb and a second limb, wherein the first limb has a first setting element and the second limb has a second setting element, the limbs being fixed in the elevator installation wherein a section, which extends along a guide direction of the guide rail, of the fastening section is arranged between the first and second limbs and a position of the section of the fastening section of the guide rail is at least one of variable and fixable within the elevator installation by adjustment of the first and the second setting elements; and
at least one fixing device by which the guide rail is fastenable to a support structure of the elevator installation.

9. A method of fastening and aligning a guide rail in an elevator installation, comprising the steps of:
arranging a first section, which extends along a guide direction of the guide rail, of a fastening section of the guide rail between a first limb and a second limb of a mounting device;
adjusting a first setting element of the mounting device for aligning the guide rail, wherein a position of the section of the fastening section between the first and second limbs is predeterminable by adjustment of the first setting element, wherein the section adopts this position when the fastening of the guide rail is concluded; and
adjusting a second setting element of the mounting device for the fastening of the guide rail in the elevator installation.

10. The method according to claim 9 including fixing the guide rail to a support structure of the elevator installation by at least one fixing device.
